(19) United States
(12) Patent Application Publication
(10) Pub. No.: US 2020/0376565 A1
(43) Pub. Date: Dec. 3, 2020

(54) ELECTROCALORIC ASSISTED INTERNAL COOLING TEXTURE TURNING TOOL AND NANOFLUID MINIMAL QUANTITY LUBRICATION INTELLIGENT WORKING SYSTEM

(71) Applicants: QINGDAO UNIVERSITY OF TECHNOLOGY, Qingdao (CN); NINGBO SANHAN ALLOY MATERIAL CO., LTD., Ningbo (CN)

(72) Inventors: Changhe LI, QINGDAO (CN); Xiaoming WANG, QINGDAO (CN); Liang LUO, NINGBO (CN); Huajun CAO, QINGDAO (CN); Bingheng LU, QINGDAO (CN); Runze LI, QINGDAO (CN); Yanbin ZHANG, QINGDAO (CN); Huiming LUO, NINGBO (CN); Yuchen DIAO, QINGDAO (CN); Haizhou XU, NINGBO (CN); Dongzhou JIA, QINGDAO (CN); Min YANG, QINGDAO (CN); Yali HOU, QINGDAO (CN)

(73) Assignees: QINGDAO UNIVERSITY OF TECHNOLOGY; NINGBO SANHAN ALLOY MATERIAL CO., LTD.

(21) Appl. No.: 16/744,135

(22) Filed: Jan. 15, 2020

(30) Foreign Application Priority Data
May 31, 2019 (CN) 201910471347.7

(51) Int. Cl. B23B 27/10; B23Q 11/10; F25B 21/00

(52) U.S. Cl. CPC B23B 27/10; B23B 2250/12; F25B 21/00; B23Q 11/1046

(57) ABSTRACT

The present disclosure proposes an electrocaloric assisted internal cooling, texture turning tool and a nanofluid minimal quantity lubrication (NMQL) intelligent working system. The electrocaloric assisted internal cooling texture turning tool comprises an internal cooling turning tool handle, a direction-adjustable nozzle and an internal cooling turning tool blade; the internal cooling turning tool blade is arranged at one end of the internal cooling turning tool handle serving as a bearing device; an internal cooling turning tool pad is arranged between the internal cooling turning tool blade and a structure of the internal cooling turning tool handle bearing the blade; an internal cooling turning tool blade pressing device is further arranged on the internal cooling turning tool handle; the internal cooling turning tool blade is tightly pressed on the internal cooling turning tool handle by the internal cooling turning tool blade pressing device.

### CROSS-REFERENCE TO RELATED APPLICATIONS

This application claims priority to Chinese Patent Application No. 201910471347.7 with a filing date of May 31, 2019. The content of the aforementioned applications, including any intervening amendments thereto, are incorporated herein by reference.

### TECHNICAL FIELD

The present disclosure relates to the technical field of machining, and particularly relates to an electrocaloric assisted internal cooling texture turning tool, a turning process system for coupling nanofluid minimal quantity lubrication (NMQL) with a micro-texture tool and an intelligent supply method.

### BACKGROUND OF THE PRESENT INVENTION

During metal cutting, cutting fluid and additives have been widely used because they can play the roles of cooling, lubrication, cleaning, chip removal and rust prevention, but they also bring many negative effects, such as environmental pollution, harm to human health and the increase in manufacturing cost, and may increase tool wear and reduce surface quality of workpieces due to improper use. With the requirements of national sustainable development strategies, the manufacturing industry in China is pursuing a high-quality, high-efficiency and low-cost production mode. Meanwhile, environmental, protection regulations have become increasingly stringent. Cooling methods of pouring a large amount of cutting fluid are no longer in line with the development direction of production. Measures must be taken to change this resource-consuming manufacturing mode to realize green and sustainable production. In recent years, all countries in the world and organizations such as the International Academy for Production Engineering (CIRP), the American Society of Mechanical Engineers (ASME) and the Institute of Electrical and Electronic Engineers (IEEE) have conducted a lot of research on cutting technology for eliminating or reducing hazards of the cutting fluid, and have made great efforts to apply the cutting technology to production practice. Dry cutting, compound machining, green cooling and other technologies can be adopted to eliminate or reduce hazards of cooling liquid, wherein dry cutting can fundamentally solve many negative effects brought by the cutting fluid, but in many cases, the service life of the tool is short and the surface roughness of the workpieces is extremely poor due to high cutting temperature, so it is not feasible to use full dry cutting. Therefore, super-hard tool materials and coated tools are generally used in dry cutting, and a high-speed cutting technology is adopted, but the theory of the high-speed cutting technology is not perfect. Compound machining technologies such as heating and ultrasonic vibration-combined assisted cutting are expensive in complete set of equipment and are in a research stage, However, pollution-free or less-pollution cooling technologies have been widely used in industry. At present, green cooling technologies such as cold air cooling, minimal quantity lubrication (MQL) cooling, water vapor, heat pipe cooling and internal cooling have emerged, and also have good cooling effects. Therefore, the technology of realizing near-dry cutting through an MQL device has feasibility and extremely high application prospect.

Traditional tribology holds that the smoother the two surfaces in contact with each other are, the smaller the amount of wear is. However, the recent research has shown that the surface with better smoothness does not have better wear resistance, but the surface with a certain non-smooth shape has better wear resistance. The research on the surface with a non-smooth shape is a research on the surface with a texture. The so-called surface texture means that geometric microstructures with certain characteristics are designed by utilizing geometric graphics theories or bionics theories, and microstructure arrays are machined on the surfaces by means of laser machining and the like to change geometries of the surfaces, thereby improving contact performance between the surfaces, reducing friction and improving lubrication conditions. Therefore, appropriate geometric microfeatures are the premise of texture modification and have great engineering value for improving, friction performance between contact pairs. The surface texture can improve the friction performance of friction pairs mainly because micro-dimples or indentations of the surface texture can play the role of an oil reservoir and can form lubricating films on the surfaces of the friction pairs in time, thereby reducing friction and wear on the surfaces of the friction pairs. The lubrication effect of the lubrication oil on the surfaces of the friction pairs is mainly realized in such a manner that the lubrication oil is driven to form the lubricating films on the surfaces by relative motion generated between the two friction pairs and reduce direct contact between the surfaces of the two friction pairs, thereby reducing the friction and wear. When dimples or indentations exist, the lubrication oil will be stored in the dimples or indentations. When the surfaces of the two friction pairs start to move relative to each other, a relative movement speed is generated. The lubrication oil adheres to the surfaces of the friction pairs due to viscosity and rapidly forms the lubricating films on the surfaces under the driving of the surfaces, thereby shortening the forming time of the lubricating films and playing the roles of resisting friction and reducing wear.

The MQL cutting technology refers to a cutting method in which a minimum quantity of lubrication liquid and a gas having a certain pressure are mixed and atomized, and then conveyed to friction interfaces to play the roles of cooling and lubrication. The high-pressure gas mainly plays the roles of cooling and chip removal. The MQL achieves or even exceeds the lubrication effect of pouring type, and has great advantages and development prospects in replacing traditional pouring type cooling lubrication. However, the research shows that the high-pressure gas with atomizing effect does not achieve the expected good cooling effect.

The NMQL inherits all the advantages of the MQL, solves a heat transfer problem of MQL cutting, and is an energy-saving, environmentally friendly, green and low-carbon cutting technology. Due to a heat transfer enhancement mechanism that heat transfer performance of solid is greater than that of liquid while the heat transfer performance of the liquid is greater than that of gas, an appropriate amount of nano-scale solid particles are added to biodegradable MQL liquid to form a nanofluid; and the NMQL liquid is atomized by compressed gas and is conveyed to tool/chip interfaces in a jet manner. The compressed gas mainly plays the roles of cooling, chip removal and nanofluid conveying. The MQL liquid mainly plays a role of lubrication. The nanoparticles enhance the heat transfer capacity of the fluid in a cutting region and play a good cooling role. Meanwhile, the nanoparticles achieve excellent anti-wear and friction-reducing characteristics and bearing capacity, thereby improving the lubrication effect of a grinding region, greatly improving the surface quality and bum phenomenon of the workpieces, effectively prolonging the service life of the tool and improving the working environment.

Traditional refrigeration modes are gas-liquid refrigeration methods, which are implemented on the basis of a vapor compression technology and mostly uses freon as a refrigerant. Once the freon enters the atmosphere, the ozone layer will be destroyed, thereby not only bringing environmental problems, but also threatening human health. The magnetic refrigeration technology is a novel solid-state refrigeration technology based on a magnetocaloric effect. The magnetocaloric effect means that a degree of order of magnetic domains is changed to cause the change of entropy of the system and thus cause the change of temperature of materials to realize refrigeration in a process of applying a magnetic field to magnetic materials or removing the magnetic field. The magnetic refrigeration requires a large magnetic field generated by a permanent magnet array to drive a refrigeration device to work. The refrigeration efficiency of the magnetic refrigeration strongly depends on strength of the magnetic field, or the size of the magnet, which limits application of the magnetic refrigeration technology to a large extent. Ferroelectric refrigeration based on an electrocaloric effect is evolved from magnetic refrigeration analogous to the magnetocaloric effect. Electrocaloric refrigeration means that a polarization state of materials is changed by applying an electric field or removing the electric field from polar materials, and the degree of order of the polarization state is changed to induce the materials to produce field-induced entropy change and temperature change, thereby realizing refrigeration.

After searching, the inventors found in the research that Zhao Qiang et al. of China National South Aviation Industry (Group) Co., Ltd. as applicants invented a turning tool, which has an application number of “CN201320711247.5” and comprises a tool handle and a tool bit. The tool handle is connected with the tool bit; the tool bit comprises a cutting section and an avoidance section which are connected with each other; the avoidance section comprises a cylindrical section and a conical section; and the conical section is arranged between the tool handle and the cylindrical section. The, technical solution effectively solves a problem of difficulty in machining an inner conical surface and an oil injection hole of the nozzle in the prior art.

After searching, Xu Guosheng et al. of Tianjin University of Technology and Education invented a finish turning tool, which has an application number of 201611070460.7 and provides the finish turning tool. The finish turning tool comprises a turning tool body and a special-shaped turning tool blade. The special-shaped turning tool blade has circular arcs of R40-50 mm as a major cutting edge and a minor cutting edge, an edge length of 8-10 mm, a circular arc surface of R6-R7 mm as a major flank face, and a circular arc surface of R6.5-R8 mm as a minor flank face; and an intersection between the major flank face and the minor flank face of the special-shaped turning tool blade is a circular arc edge, which, participates in turning as a cutting edge during turning. The finish turning tool provided by the present invention can effectively improve stress conditions of the tool and a discharge direction of chips when a cutting depth is less than 0.05 mm during finish turning, avoids problems of scratching a machined surface due to vibration, extrusion-cutting and cutting, and reduces finish turning difficulty and workpiece surface roughness by performing finish machining while, turning. However, the finish turning tool provided by the present invention has a small application scope and has little guiding significance for the manufacturing of turning tools in other working conditions and machining environments.

After searching, Wu Yuanbo et al. of University of Jinan invented a composite surface texture friction pair, which has an application number of 201820389723.9, discloses the composite surface texture friction pair and belongs to the technical field of mechanical motion friction pair surfaces. The composite surface texture friction pair comprises an upper surface friction pair and a lower surface friction pair. A composite surface texture is machined on the surface of the lower surface friction pair; the composite surface texture comprises a plurality of first grooves and second grooves and a plurality of first dimples and second dimples; the plurality of first grooves are arranged in parallel; the plurality of second grooves are arranged in parallel; the first, grooves and the second grooves are arranged in a manner of intersecting with each other to form a mesh-like groove texture; the plurality of first dimples are arranged along the mesh-like groove texture in sequence so that the plurality of first dimples are communicated by the mesh-like groove texture; and the plurality of second dimples are arranged along a center of a rhombic grid formed by the mesh-like groove texture. The composite surface texture friction pair according to the utility model improves a lubrication state of an oil film boundary and reduces the friction coefficient and wear capacity by utilizing the surface texture machined on the surface of the motion friction pair, However, the composite surface texture friction pair in the patent has a single type of friction texture, only combines two textures simply and does not explain applicable working, conditions of the textures, so that the textures cannot be further applied in practice.

However, the above patents have solved the problem of green cooling lubrication, or wear resistance of the tool during turning to a certain degree or have developed novel internal cooling tools, but some defects or reasonable solutions for other necessary problems still exist.

The internal cooling tools have a problem of insufficient heat transfer during machining of difficult-to-machine materials with relatively small thermal conductivity coefficients. Heat cannot be transferred in time due to the, relatively small thermal conductivity coefficients in a process of machining the materials with relatively small thermal conductivity coefficients, which easily causes burns on the machined surfaces or adhesion due to combined effect of the chips and props at high temperature, thereby reducing the machining performance and machining precision of the tools.

### SUMMARY OF PRESENT INVENTION

The purpose of embodiments of the description is to provide an electrocaloric assisted internal cooling texture turning tool, which realizes the design of a direction-adjustable internal cooling spray head with an atomization effect, and further realizes the precise and controllable supply of MCL liquid.

Embodiments of the description provide the electrocaloric assisted internal cooling texture turning tool, which is realized by the following technical solution:

The electrocaloric assisted internal cooling texture turning tool comprises:

an internal cooling turning tool handle, a direction-adjustable nozzle and an internal cooling turning tool blade, wherein

the internal cooling turning tool blade is arranged at one end, of the internal, cooling turning tool handle serving as a bearing device; an internal cooling turning tool pad is arranged between the internal cooling turning tool blade and a structure of the internal cooling turning tool handle bearing the blade;

the internal cooling turning tool handle is made of an electrocaloric material, is externally connected with an electric field, and is internally and externally coated with insulation coatings having excellent thermal conductivity;

an internal cooling turning tool blade pressing device is further arranged on the internal cooling turning tool handle; the internal cooling turning tool blade is tightly pressed on the internal cooling turning tool handle by the internal cooling, turning tool blade pressing device;

a texture is machined on a rake face of the internal cooling turning tool blade;

the internal cooling turning tool blade pressing device has a hollow structure, and is also provided with the direction-adjustable nozzle; and the internal cooling, turning tool blade pressing device is communicated with an internal channel of the direction-adjustable nozzle.

Embodiments of the present specification provide an NMQL intelligent working system, which is realized by the following technical solution:

The NMQL intelligent working system comprises:

a machine tool working system, an electrocaloric tool handle radiating fin movement system, an MQL supply system and a texture turning tool component;

the MQL supply system and the texture turning tool component are mounted on the machine tool working system:

the electrocaloric tool handle radiating fin movement system is mounted on a turning tool holder and mainly radiates heat of the turning tool handle made of the electrocaloric material;

the MQL supply system mainly provides pulsed lubrication and cooling liquid for the texture turning tool component:

the texture turning tool component is the electrocaloric assisted internal cooling texture turning tool; workpieces mounted in the machine tool working system are rotated; the texture turning tool component performs linear motion under the action of the machine tool working system; and the texture turning tool component cuts the work-pieces to generate chips, thereby removing materials of the workpieces.

Embodiments of the present specification provide a process method for coupling NMQL and the texture tool, which is realized by the following technical solution:

the process method comprises:

pouring formulated MQL oil or NMQL oil into the MQL supply system;

mounting the texture turning, tool, component in the machine tool working system, and then positioning and clamping;

mounting the workpieces above the machine tool working system, and then positioning and clamping;

determining cutting parameters, then inputting machine tool machining parameters into the MQL supply system, establishing a parameter matching database, intelligently identifying the cutting parameters, matching with an optimal liquid supply amount of the MQL supply system, and controlling an intelligent supply motor to move and drive a gear-rack transmission mechanism, thereby adjusting the amount of chips and realizing intelligent supply of the amount of chips and liquid supply amount.

The workpieces are always rotated in the process of machining the workpieces, while the texture turning tool component performs linear motion under the action of the machine tool working system; and the texture turning tool component cuts the workpieces to generate the chips, thereby removing the materials of the workpieces.

Compared with the prior art, the present disclosure has beneficial effects as follows.

The electrocaloric assisted internal cooling texture turning tool according to the present disclosure realizes the design of a direction-adjustable internal cooling spray head with an atomization effect, and further realizes the precise and controllable supply of MQL liquid. Internal cooling, is adopted to reduce the temperature and enhance heat transfer, thereby prolonging service life of the tools.

NMQL is adopted in the present disclosure, i.e., nanoparticles are added into the MQL oil, and then a dispersant is added to obtain stable nanofluids with good dispersibility. The excellent heat transfer performance of the nanoparticles is utilized to reduce the temperature of a high-temperature region.

The texture tool is adopted in the present disclosure; and the texture can be machined on the surface of a turning tool to reduce the friction coefficient of a friction region, thereby reducing heat energy generated by friction.

The internal cooling turning tool is adopted in the present disclosure; a special liquid supply route of the internal cooling turning tool is utilized to bring more NMQL oil into a heat production region. Therefore, the internal cooling turning tool can be applied to greatly reduce the cutting temperature, clean up fine chips and improve the service life of the tool.

The structure of the internal cooling turning tool according to the present disclosure is relatively high in manufacturing precision and assembly precision; and since the size of the turning tool is not large, the size of the liquid supply channel of the internal cooling turning tool is matched with that of the internal cooling turning tool.

A liquid supply position of the internal cooling, turning tool is closer to the rake face and a chip friction region which actually need lubrication and cooling, so that the effects of cooling and lubrication are good.

The process system for coupling NMQL with the texture tool according to the present disclosure solves the problems of, environmental pollution, harm to human health, increase of manufacturing cost and the like caused by the traditional lubrication mode in the form of MQL, and realizes the reduction of environment-friendly cutting force and the transmission, of cutting heat. On the other hand, the surface texture can improve the friction performance of the friction pairs mainly because the micro-dimples or indentations of the surface texture can play the role of the oil reservoir and can form the, lubricating films on the surfaces of the friction pairs in time, thereby reducing the friction and wear on the surfaces of the friction pairs and prolonging the service life of the turning tool in the process system. Therefore, the process system provided by the invention realizes green manufacturing with long, service life and low energy consumption, promotes the improvement of relevant major strategies such as the conversion of new and old kinetic energies and the 13th Five-Year Plan by combining the above various functions.

The process method for coupling NMQL with the texture tool according to the present disclosure can realize low-damage and low-energy-consumption green removal of various cutting materials comprising difficult-to-machine materials through the coupling effect of the NMQL and the texture tool. An exponential equation of the cutting force is established to theoretically guide the cutting parameters of the tool. The cutting parameters are intelligently identified and matched with the optimal liquid supply amount of the MQL supply device to realize the intelligent supply of the amount of the chips and the, liquid supply amount. The present disclosure integrates a turning tool wear state image acquisition device and a tool temperature monitoring device, to improve an intelligence degree of the entire machining system and controllability of the machining process and reduce an unqualified rate of the machined workpieces.

Different MQL states are analyzed, and the lubrication conditions are combined with texture types. The optimal lubrication condition in microscopic state is found, i.e., the lubrication condition in which the NMQL is coupled with micro-texture.

### DESCRIPTION OF THE DRAWINGS

The accompanying drawings forming a part of the present disclosure are adopted to provide a further understanding of the present disclosure. Exemplary embodiments of the present disclosure and descriptions thereof are intended to illustrate the present disclosure, rather than improperly limit the present disclosure.

FIG. 1 is a schematic diagram of an overall structure of an electrocaloric assisted internal cooling texture turning tool and a supply device thereof according to an embodiment I of the present disclosure;

FIG. 2 is a schematic diagram of an overall structure of the electrocaloric assisted internal cooling texture turning tool according to an embodiment I of the present disclosure;

FIG. 3(a) is an explosion diagram of an electrocaloric assisted internal cooling texture turning tool according to an embodiment I of the present disclosure;

FIG. 3(b) is a schematic diagram of a structure of a pin in an electrocaloric assisted internal cooling texture turning tool according to an embodiment I of the present disclosure;

FIG. 4 is a sectional view of an atomization portion of a pressing plate part with a fluid channel according to an embodiment I of the present disclosure;

FIG. 5(a) is a sectional view of an electrocaloric assisted internal cooling texture turning tool according to an embodiment I of the present disclosure;

FIG. 5(b) is a schematic diagram of a structure of an internal cooling turning tool blade of an electrocaloric assisted internal cooling texture turning tool according to an embodiment I of the present disclosure;

FIG. 6 is a schematic diagram of an electrocaloric tool handle radiating fin movement system of an internal cooling turning tool according to an embodiment I of the present disclosure;

FIG. 7 is a schematic diagram of a working cycle of an electrocaloric tool handle radiating fin movement system of an internal cooling turning tool according, to an embodiment I of the present disclosure;

FIG. 8 is a schematic diagram of an NMQL turning tool process system according to an embodiment II of the present disclosure;

FIG. 9 is an isometric view of, a machine tool according to an embodiment II of the present disclosure;

FIG. 10 is, an explosion diagram of a structure of an NMQL supply system according to an embodiment II of the present disclosure;

FIG. 11 is a schematic diagram of intelligent supply of MQL according to an embodiment of the present disclosure;

FIG. 12 is a schematic diagram of force of a turning tool according to an embodiment of the present disclosure;

FIG. 13 is a schematic diagram of force coordinate analysis of a turning tool according to an embodiment of the present disclosure;

FIG. 14 is a schematic diagram of different types of texture forms according to an embodiment of the present disclosure;

FIGS. 15(a)-15(b) are a schematic diagram and a partial enlarged view of a capillary phenomenon during turning according to an embodiment of the present disclosure;

FIG. 16(a)-16(c) are microscopic schematic diagrams in a dry cutting state, a pouring type or MQL state and NMQL state according to an embodiment of the present disclosure;

FIG. 17 is a sectional diagram of a triangular cross-sectional texture according to an embodiment of the present disclosure;

FIG. 18 is a sectional diagram of a quadrilateral cross-sectional texture according to an embodiment of the present disclosure; and

FIG. 19 is a sectional diagram of an elliptical cross-sectional texture according to an embodiment of the present disclosure.

In the figures, I-machine tool working system, II-workpiece, III-texture turning tool component, IV-MQL supply system, V-turning tool wear state monitoring system, and VII-electrocaloric tool, handle radiating fin movement system:

I-1-headstock, I-2-adjusting knob, I-3-workpiece clamping device, I-4-machine tool guide rail, I-5-turning tool component, I-6-tip, I-7-tip fixing knob, I-8-lead screw motor, I-9-machine tool tailstock base, I-10-machine tool tailstock, I-11-rotary tool holder component, I-12-longitudinal lead screw motor, and I-13-machine tool body:

III-1-direction-adjustable nozzle, III-2-internal cooling turning tool blade pressing device, III-3-internal cooling turning tool positioning pin, III-4-3-major flank face, III-4-2-rake face, III-4-1-minor flank face, III-4-internal cooling turning tool blade, III-5-internal cooling turning tool pad, III-6-internal cooling turning tool handle, III-7-internal cooling turning tool air pipe connector, III-8-nozzle sealing ring, III-9-internal cooling turning tool sealing screw, III-10-turning tool sealing screw sealing ring, III-11-upper sealing screw, III-12-upper sealing ring, III-1-1-direction-adjustable nozzle gas channel, III-1-2-direction-adjustable nozzle lubrication, oil channel, III-4-a-open texture faun, III-4-b-hybrid texture form, III-4-c-closed texture form, and III-4-d-semi-open texture form;

IV-1-box body, IV-2-oil cup connector, IV-3-oil cup, IV-4-fixing screw, IV-5-washer, IV-6-fixing screw, IV-7-lubrication pump fixing cover, IV-8-precise MQL pump, IV-9-gas volume adjustment knob, IV-10-tee, IV-11-electromagnetic valve, IV-12-air source processor, IV-13-air inlet interface, IV-14-bidirectional connector, IV-15-frequency generator, IV-16-pipe, IV-17-pipe, IV-18-pipe, IV-19-oil quantity adjustment knob, IV-20-lubrication pump outlet connector, IV-21-intelligent supply gear, IV-22-intelligent supply motor stand, IV-23-intelligent supply motor base, IV-24-intelligent supply slide rail rack, and IV-25-intelligent supply motor;

VI-1-chip, VI-2-nanoparticle, VI-3-texture turning tool, VI-4-MQL oil, VI-5-micro-chip, and VI-6-microscopic capillary channel;

VII-1-radiating plate, VII-2-air cylinder, VII-3-upper intake pipe, and VII-4-lower intake pipe.

### DETAILED DESCRIPTION OF PREFERRED EMBODIMENTS

It should be noted that the following detailed illustration is exemplary and is intended to provide further explanation of the present disclosure. Unless otherwise specified, all technical and scientific terms used herein have the same meanings as commonly understood by those ordinary skilled in the art to which the present disclosure belongs.

It should be noted that the terms used herein is intended to describe specific embodiments only, rather than limit exemplary embodiments according to the present disclosure. As used herein, the singular form is also intended to comprise the plural form unless otherwise clearly specified in the context. In addition, it should be understood that the terms “contain” and/or “comprise” used in the present description indicate the presence of features, steps, operations, devices, components and/or combinations thereof

### Embodiment I

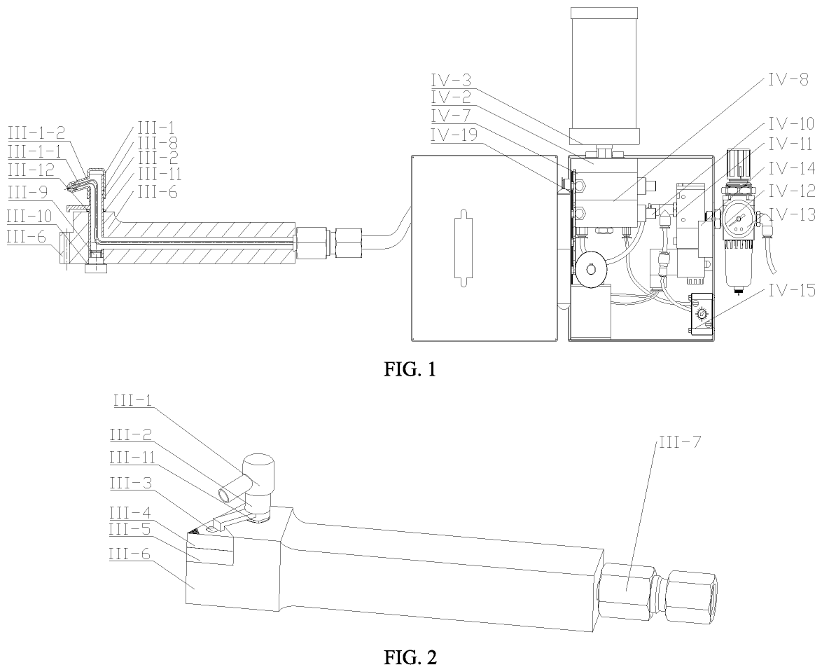

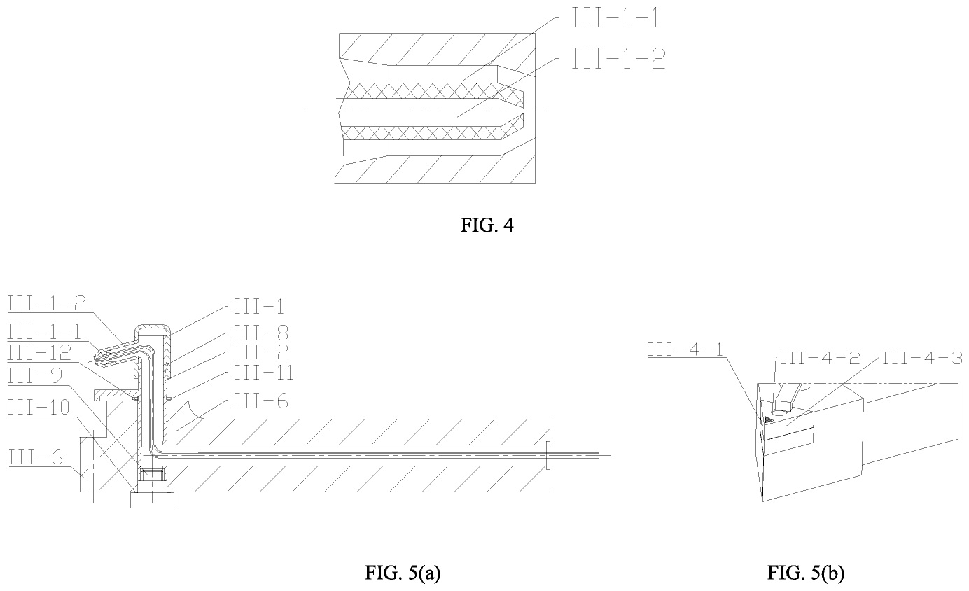

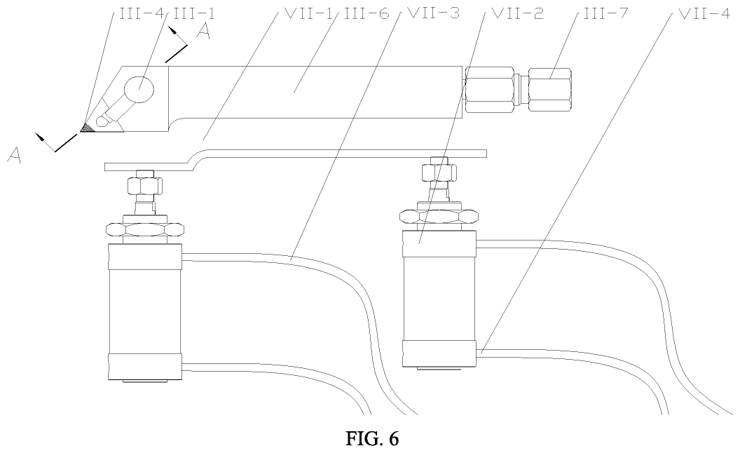

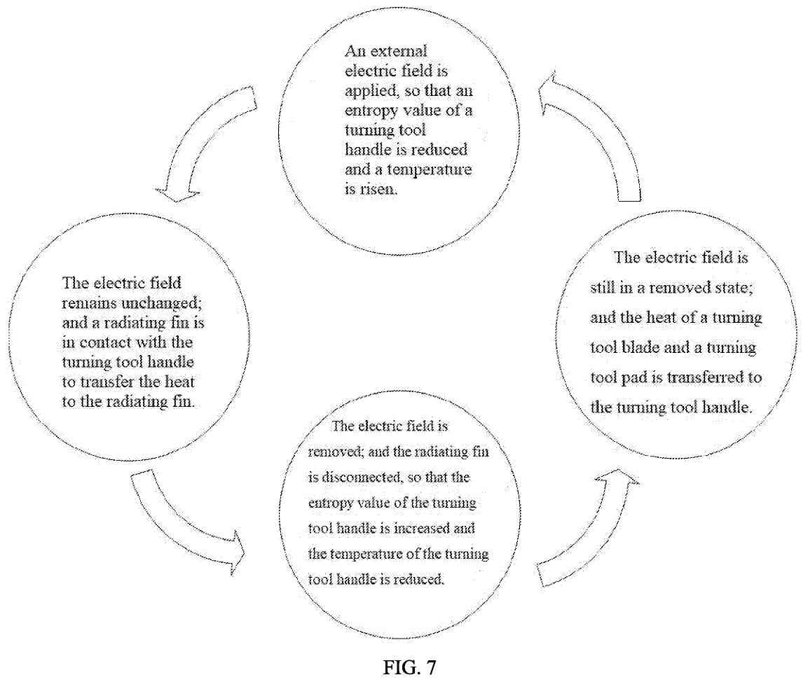

The present embodiment discloses an electrocaloric assisted internal cooling texture turning tool. As shown in FIGS. 1-7, the texture internal cooling turning tool comprises a direction-adjustable nozzle III-1, an internal cooling turning tool blade pressing device III-2, an internal cooling turning tool positioning pin III-3, an internal cooling turning tool blade III-4, an internal cooling turning tool pad III-5, an internal cooling turning tool handle III-6, an internal cooling turning tool air pipe connector III-7, a nozzle sealing ring III-8, an internal, cooling turning tool sealing screw III-9, a turning tool sealing screw sealing ring III-10, a direction-adjustable nozzle gas channel III-1-1 and a direction-adjustable nozzle lubrication oil channel III-1-2.

The internal cooling turning tool blade III-4 is a main working part of turning. A workpiece is rotated while working, and the internal cooling turning tool blade III-4 performs linear feeding motion. A major cutting edge of the tool will cut the workpiece to generate chips at this moment, which will cause friction between the chips and a rake face of the turning tool blade while causing friction between a flank face of the turning tool blade and a machined surface of the workpiece.

FIG. 5(b) is a specific structure of the internal cooling turning tool blade, comprising a major flank face III-4-3, the rake face III-4-2 and a minor flank face III-4-1. FIG. 5(a) is a sectional view of the electrocaloric assisted internal cooling texture turning tool according to the embodiment I of the present disclosure.

In a specific embodiment, the internal cooling turning tool pad III-5 has the same shape as the internal cooling turning tool blade III-4 and has thickness size and center hole size different from the internal cooling turning tool blade III-4. The internal cooling turning tool pad mainly aims to avoid that the internal cooling turning tool blade III-4 is deformed because of bearing too large cutting resistance, and uniformly transmit the cutting resistance borne by the internal cooling turning, tool blade III-4 to the internal cooling turning tool handle III-6 by the internal cooling turning tool pad III-5.

The internal cooling turning tool handle III-6 is a bearing device of the internal cooling turning tool blade III-4 and the internal cooling turning tool pad III-5, and plays a major role of fixedly connecting various components of an internal cooling turning tool together and then fixedly connecting to a rotary tool holder component I-11 of a machine tool system by bolts.

The internal cooling turning tool positioning pin III-3 is a special pin for locating the internal cooling turning tool blade III-4 and the internal cooling turning tool pad III-5.

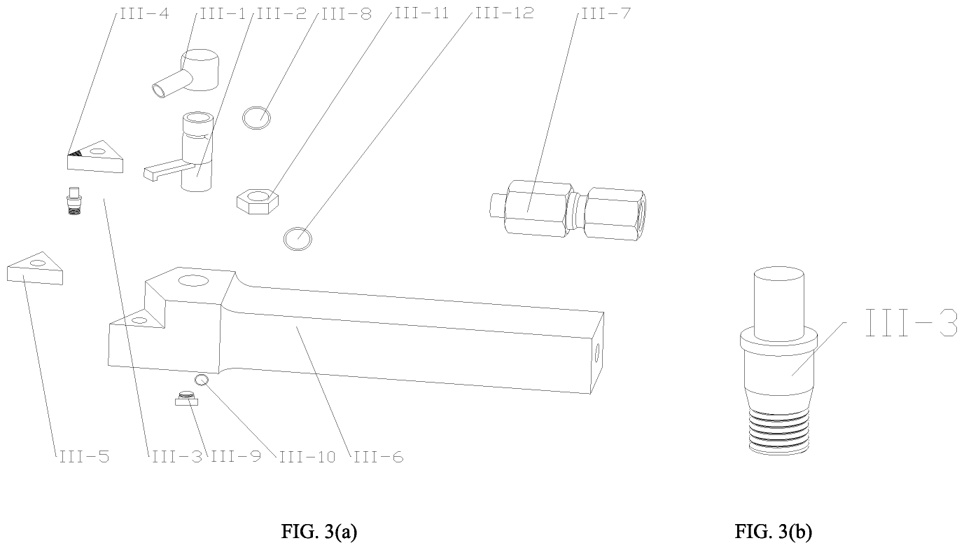

The special pin mentioned here is not specially made of or treated by materials and the like. It is called the special pin because the pin is used as a mechanical part with production standards and has a structure, shape and size with certain standards in actual production. The pin used in the present disclosure has the same function as that of a standard part, but has the structure different from that of the standard part of a traditional pin, i.e., a non-standard part, thereby becoming the special pin here. A structural diagram of the special pin is shown in FIG. 3(b). FIG. 3(a) is an explosion diagram of the electrocaloric assisted internal cooling texture turning tool according to the embodiment I of the present disclosure.

The pressing device according to the present embodiment is different from an existing pressing device, and the existing pressing device can only provide a pressing effect but cannot provide other effects. However, the pressing device involved in the present disclosure can also be used as a circulation device for gas, and an MQL liquid pipe while providing the pressing effect.

The internal cooling turning tool blade pressing device III-2 is a pressing device of the internal cooling turning tool blade III-4, presses an external cooling turning tool blade to play a clamping role, and is fixedly connected with the internal cooling turning tool sealing screw III-9 in a manner of threaded connection. The turning tool sealing screw sealing ring III-10 is arranged between the internal cooling turning tool sealing screw III-9 and the internal cooling turning tool handle III-6. The part is hollow to allow the gas and the MQL liquid, pipe to pass through.

Under combined action of the internal cooling, turning tool sealing screw III-9, the internal cooling turning tool handle III-6, the upper sealing screw III-11 and the upper sealing ring III-12, the compressed gas and the liquid pipe of the turning tool channel can flow to the direction-adjustable nozzle III-1. The internal cooling turning tool sealing screw III-9 provides guarantee for maintenance of turning tool faults, thereby prolonging the service life of the entire component.

The direction-adjustable nozzle III-1 is a direction-adjustable internal cooling turning tool nozzle with an atomization device. The nozzle comprises the direction-adjustable nozzle gas channel III-1-1 and the direction-adjustable nozzle lubrication oil channel III-1-2, and can mix and atomize gas and the MQL oil. The turning tool sealing screw sealing ring III-10 and the internal cooling turning tool sealing screw III-9 are standard parts for sealing the gas channel of the texture internal cooling turning tool.

The internal cooling turning tool air pipe connector III-7 is a connection device of an MQL supply device and an internal cooling turning tool lubrication liquid interface, and has one end connected with the internal cooling turning tool handle III-6 and the other end connected with a pipeline of an MQL supply system IV.

The texture with a certain areal density, width and depth is machined on the rake face of the internal cooling turning tool blade. The texture comprises an open texture, a semi-open texture, a closed texture and a hybrid texture.

The open texture means that the fluid in the texture can flow freely in the texture, i.e., can move in one direction and also flow in a direction with a certain angle to the direction.

The semi-open texture means that the fluid in the texture can only move in one direction under the action of the texture.

The closed texture means that the fluid in the texture does not move in other directions.

The hybrid texture is a combination of the open texture, the semi-open texture and the closed texture in pairs or in threes.

During operation, referring to FIG. 5(a) again, the liquid pipe flowing out of a gas-liquid mixing outlet IV-5 of the MQL supply system IV finally enters the direction-adjustable nozzle gas channel III-1-1 through the internal cooling turning tool handle III-6 and the, internal cooling turning tool blade pressing device III-2.

Compressed air enters the internal cooling turning tool handle III-6 and the internal cooling turning tool blade pressing device III-2 through the internal cooling turning tool air pipe connector III-7, and finally reaches the direction-adjustable nozzle lubrication oil channel III-1-2 to interact with the liquid pipe to generate atomized droplets of the MQL oil.

The novel internal cooling turning tool component according to the present embodiment realizes the design of a steerable internal cooling nozzle with the atomization effect and electrocaloric assisted refrigeration, and further realizes the precise and controllable supply of MQL liquid and excellent cooling of the blade.

### Embodiment II

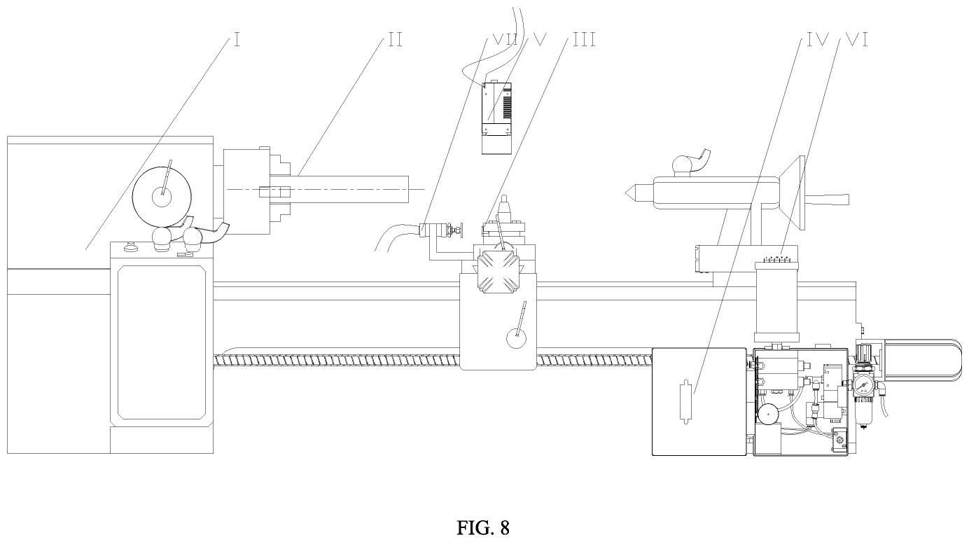

The present embodiment discloses that the present specification provides an, intelligent working system of NMQL. As shown in FIGS. 8-11, the intelligent working system is realized by the following technical solution:

The intelligent working system comprises:

a machine tool working system, an MQL supply system and a texture turning tool component;

the MQL supply system and the texture turning tool component are mounted on the machine tool working system;

the MQL supply system mainly provides pulsed lubrication and cooling liquid for the texture turning tool component;

the texture turning tool component refers to the electrocaloric assisted internal cooling texture turning tool; workpieces mounted in the machine tool working system are rotated; the texture turning, tool component performs linear motion under the action of the machine tool working system; and the texture turning tool component cuts the workpieces to generate chips, thereby removing materials of the workpieces.

The machine tool working system II can be an engine lathe and can also be a numerically controlled lathe (CNC lathe). The whole process system is described by taking the engine lathe for example in the present invention. In the case of same components or structures, the process system of the CNC lathe still belongs to the content of the present invention. The workpieces II refer to parts that need to be machined, and are generally rotary parts. The texture turning tool component mainly refers to a cutting part for turning. The MQL supply device IV mainly provides pulsed lubrication and cooling liquid for the texture turning tool component

In one embodiment, the intelligent working system further comprises a turning tool wear state monitoring system V. The turning tool wear state monitoring system V integrates an, infrared thermal imager acquisition module and an image acquisition device, and can monitor a wear state of, the turning tool and the temperature of the turning tool component.

When machining an initial position, the image acquisition device of the turning tool wear state monitoring system V acquires an initial state of the turning tool and stores the initial state in a memory. After finishing machining one part, the turning tool returns to the initial position, and the image acquisition device acquires an image of the turning tool blade and compares the image of the turning tool in the initial state with image blocks. A reference value of the turning tool wear state is obtained after comparison of the image blocks and data weighted accumulation. The reference value can be compared with a turning tool wear threshold corresponding to precision requirements of the machined workpiece to decide whether to replace the turning tool. The weighted accumulation means that the wear of a portion near the cutting edge of the turning tool is given a higher weight, the wear of a portion far away from the cutting edge of the turning tool is given a lower weight, and cumulative addition is performed to obtain the reference value of the turning tool wear state.

In another embodiment, the intelligent working system further comprises an electrocaloric tool handle radiating fin movement system, which comprises a radiating plate, a lower intake pipe, air cylinders and an upper intake pipe.

Specifically, the air cylinders are arranged below the radiating plate: the number of the air cylinders may be two; and each air cylinder is respectively connected to the upper intake pipe and the lower intake pipe.

The electrocaloric tool handle radiating fin movement system periodically electrifies the turning tool handle made of the electrocaloric material in a periodic cycle; and the radiating fin periodically moves along, specifically as follows.

1. An electric field is applied in the internal cooling turning tool handle III-6 and the internal cooling turning tool pad III-5; dipoles in the internal cooling turning tool handle III-6 and the internal cooling turning tool pad III-5 will be arranged orderly due to the action of the electric field, so that an entropy value of the entire component is reduced and the temperature is, further risen.

2. The electric field remains unchanged. The temperature rise caused by reduction of the entropy value is radiated by the radiating plate VII-1; the lower intake pipe VII-4 of the radiating plate VII-1 works to push the air cylinder VII-2 to move forward; the radiating plate VII-1 is in contact with the internal cooling turning tool handle III-6 and the internal cooling turning tool pad III-5 to transfer the heat of the internal cooling turning tool handle III-6 and the internal cooling turning tool pad III-5 to the radiating plate VII-1.

3. The electric field is removed; meanwhile, the upper intake pipe VII-3 is ventilated to push the air cylinder VII-2 back. The dipoles in the internal cooling turning tool handle III-6 and the internal cooling turning tool pad III-5 are disorderly arranged at this moment due to withdrawal of the electric field, so that the entropy value is increased and the temperature is reduced.

4. The electric field is still in a removed state. The temperatures of the internal cooling turning tool handle III-6 and the internal cooling turning tool pad III-5 are lower than that of the internal cooling turning tool blade III-4, and the heat is transferred to the turning tool handle at this moment.

Thus, the cycle is repeated to reduce the temperature of the components.

A workflow of the whole system is as follows: pouring formulated MQL oil or NMQL oil into, the MQL supply system IV before the whole system works; mounting the texture turning tool component III in the machine tool working system I, and then positioning and clamping; and in addition, mounting the workpieces II above the machine tool working system I, and then positioning and clamping.

It should be noted that the MQL is different from the NMQL that the NMQL is to add the nanoparticles and a dispersant on the basis of the MQL oil, thereby uniformly and stably dispersing the nanoparticles in the MQL oil as a liquid medium to form the nanofluid with good dispersibility, high stability, high durability and low agglomeration.

The workpieces II are always rotated in the process of machining the workpieces II, while the texture turning tool component III performs linear motion under the action of the machine tool working system I. The texture turning tool component III cuts the workpieces II to generate the chips, thereby removing the materials of the workpieces

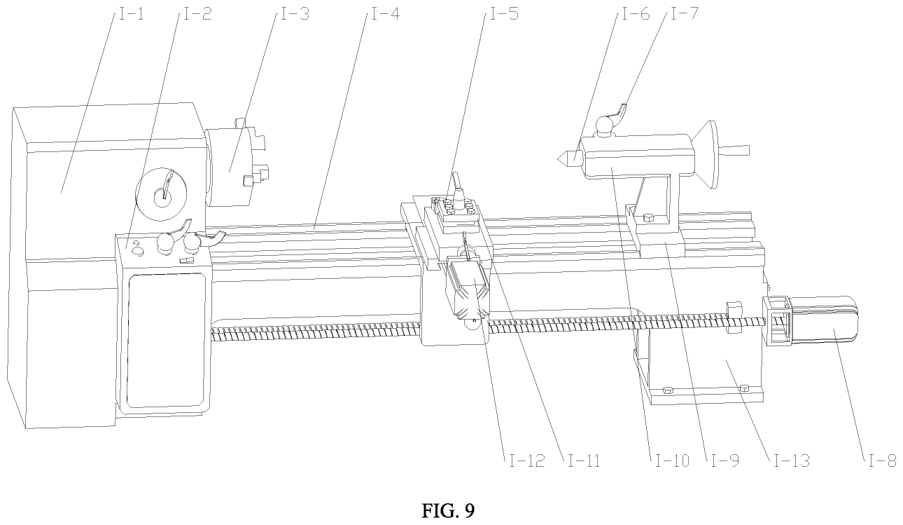

Referring to FIG. 9, a turning machine tool working system I comprises a spindle box I-1, an adjusting knob I-2, a workpiece clamping device I-3, a machine tool guide rail I-4, a turning tool component I-5, a tip I-6, a tip fixing knob I-7, a lead screw motor I-8, a machine tool tailstock base I-9, a machine tool tailstock I-10, a rotary tool holder component I-11 and a longitudinal lead screw motor I-12. A machine tool body I-13 is mainly made of cast iron and machined by a casting, technology, and mainly plays the roles of connecting various components together and stably fixing the machine tool working system I on the ground. The spindle box I-1 is a complex transmission component of the turning machine tool working system I, and mainly plays the roles of realizing rotation movement of the workpiece clamping device I-3, realizing change of different rotating speeds of the workpiece clamping device I-3, start and stop of the workpiece clamping device I-3 and a rotating direction of the workpiece clamping device I-3 and the like. The adjusting knob I-2 can be rotated to adjust a transmission mechanism of the spindle box I-1 to control the change of the start and stop, the rotating speeds and the rotating direction of the workpiece clamping device I-3. A device such as a three jaw chuck, a four-jaw chuck or a disk chuck can be selected as the workpiece clamping device I-3 according to actual part machining process requirements, and mainly plays the roles of centering and clamping. The rotary tool holder component I-11 mainly plays the role of mounting and fixing the texture turning tool component III. Four tools can be mounted on the rotary tool holder component I-11 at the same time. The principle is that the texture turning tool component III is fixed on the rotary tool holder component I-11 by screws. The longitudinal movement of the rotary tool holder component I-11 is completed by driving a lead screw to move by the longitudinal lead screw motor I-12. The machine tool guide rail I-4 is precisely matched with a worktable of the rotary tool holder component I-11 so as to realize the transverse movement of the rotary tool holder component I-11. The lead screw motor I-8 is a power source for the rotary motion of a lead screw. The machine tool tailstock base I-9 is precisely matched with the machine tool guide rail I-4 to realize the linear movement of the, machine tool tailstock I-10 on a guide rail. The tip fixing knob I-7 refers to a fixing knob of the tip I-6. The tip I-6 and the machine tool tailstock base I-9 are relatively stationary by rotating the tip fixing knob I-7. The tip I-6 refers to an auxiliary device for the, turning process. When turning a slender shaft, the machine tool tip I-6 can support the slender shaft to reduce the vibration of the slender shaft during machining and improve the machining precision of the workpieces to be machined. The tip I-6 can be replaced with a drilling tool to drill the workpieces or other types of tools for, rotary machining of the workpieces. The workpieces II are generally bar stocks, and can also be disks, sleeves or other workpieces with rotary surfaces, such as inner and outer cylindrical surfaces, inner and outer conical surfaces, end surfaces, grooves, threads and rotary forming surfaces.

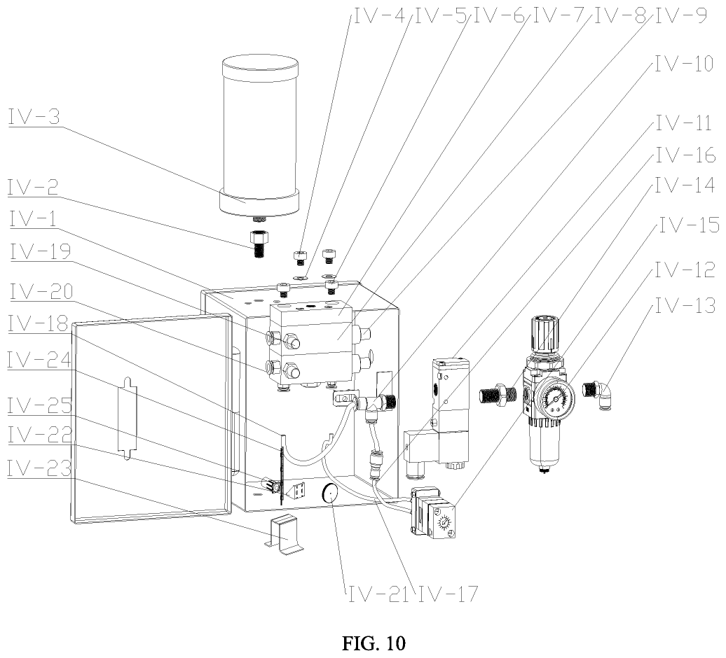

As shown in FIG. 10, the MQL supply system IV comprises a box body IV-1, an oil cup connector IV-2, an oil cup IV-3, a fixing screw IV-4, a washer IV-5, a fixing screw IV-6, a lubrication pump fixing cover IV-7, a precise MQL pump IV-8, a gas volume adjustment knob IV-9, a tee IV-10, an electromagnetic valve IV-11, an air source processor IV-12, an air inlet interface IV-13, a bidirectional connector IV-14, a frequency generator IV-15, a pipe IV-16, a pipe IV-17, a pipe IV-18, an oil quantity adjustment knob IV-19, a lubrication pump outlet connector IV-20, an intelligent supply gear IV-21, an intelligent supply motor stand IV-22, an intelligent supply motor base IV-23, an intelligent supply slide rail rack IV-24 and an intelligent supply motor IV-25. The air inlet interface IV-13 is fixed on the air source processor IV-12. A high-pressure gas enters the air source processor IV-12 through the air inlet interface IV-13 and is filtered to provide the high-pressure gas for the lubrication system. The air source processor IV-12 is connected to the electromagnetic valve IV-11 through the bidirectional connector IV-14 to control the entrance of the gas. An outlet of the electromagnetic valve IV-11 is connected with the tee IV-10. The high-pressure gas enters the frequency generator IV-15 through an outlet pipeline IV-16 of the tee IV-10; an input frequency of the gas is controlled by the frequency generator IV-15; and the high-pressure gas enters the precise MQL pump IV-8 through the pipe IV-17 after coming out of the frequency generator IV-15. In addition, the high-pressure gas enters the precise MQL pump IV-8 through the other outlet pipe IV-18 of the tee IV-10; one end of the oil cup connector IV-2 is connected with oil cup IV-3 by threads, while the other end is connected with the lubrication pump fixing cover IV-7 by the threads; the lubrication pump fixing cover IV-7 is connected with the precise MQL pump IV-8 by two fixing screws IV-6, and is fixed on the box body IV-1 by two fixing screws IV-4 and washers IV-5; the gas volume of high-pressure gas is adjusted by the gas volume adjustment knob IV-9; the oil quantity of the lubrication oil is adjusted by the oil quantity adjustment knob IV-19; and finally, the lubrication oil is supplied to the cutting system IV by connecting the lubrication, pump outlet connector IV-20 with the nozzle connector IV-6.

The intelligent supply gear IV-21 is connected with the intelligent supply motor IV-25 in a manner of key connection; the intelligent supply motor IV-25 is mounted on the intelligent supply motor stand IV-22 in a manner of bolt connection; the intelligent supply motor stand IV-22 is fixedly connected with the intelligent supply motor base IV-23 in the manner of bolt connection: and the intelligent supply motor base IV-23 is fixedly connected with the box body IV-1 in a welding manner. The intelligent supply slide rail rack IV-24 is fixedly connected with the box body IV-1 in the welding manner and is matched with the intelligent supply gear IV-21 for transmission.

An MQL intelligent adjustment and supply system can drive gear rack components by the motor according to actual machining and further adjust a supply quantity knob to realize intelligent adjustment of supply quantity parameters of the MQL oil.

The basic principle of the MQL supply system IV is to pneumatically transport the MQL oil to the nozzle in a pulsing manner (i.e., at intervals), then atomize at the nozzle or the internal cooling turning tool and spray to a designated position.

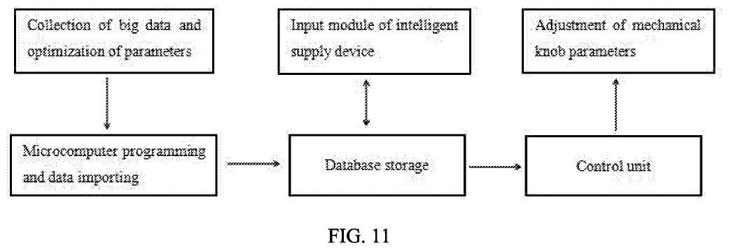

In one embodiment, referring to FIG. 11, when the intelligent MQL supply is realized, the supply amount of the MQL supply system corresponding to the cutting parameters with long-term practical experience can be inputted into a memory of a control unit by a microcomputer module. When changing machining parameters, the parameters are inputted into a signal input device; data in the corresponding memory are extracted into the supply amount; and then a mechanical device adjustment knob of the MQL supply device is adjusted to adjust the supply amount.

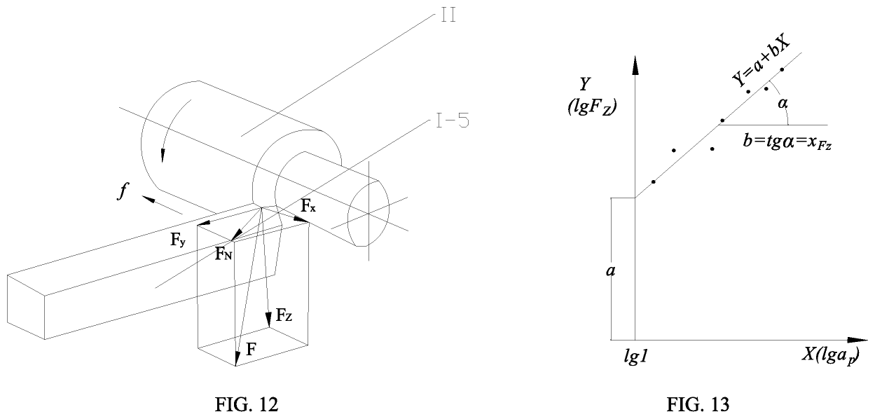

As shown in FIGS. 12 and 13, the forces in the cutting process comprise a cutting force F_{Z}, a back force F_{Y}, and a feed force F_{X}.

An exponential equation of the cutting force is obtained through a large number of experiments. The cutting force is measured by a dynamometer, and then the obtained data are processed with a mathematical method to obtain an empirical equation for calculating the cutting force.

F_{Z}=C_{Fz}aₚ^{X}^{_{Fz}}f^{Y}^{_{Fz}}vⁿ^{_{Fz}}K_{Fz}

F_{Y}=C_{Fy}aₚ^{X}^{_{Fy}}f^{Y}^{_{Fy}}vⁿ^{_{Fy}}K_{Fy}

F_{X}=C_{Fx}aₚ^{X}^{_{Fx}}f^{Y}^{_{Fx}}vⁿ^{_{Fx}}K_{Fx}

F_{Z} refers to the cutting force;

F_{Y} refers to the back force;

F_{X} refers to the feed force:

C_{Fz}, C_{Fy} and C_{Fx} depend on coefficients of metal to be processed and cutting conditions;

X_{Fz}, Y_{Fz}, n_{Fz}, X_{Fy}, Y_{Fy}, n_{Fy}, X_{Fx}, Y_{Fx} and n_{Fx} respectively refer to indices of a back cutting depth aₚ , a feed rate f and a cutting speed ν in three component force equations;

K_{Fz}, K_{Fy} and K_{Fx} respectively refer to products of correction coefficients of various factors on the cutting force when actual machining conditions do not match with the conditions for obtaining the empirical equation in calculation, of three component forces.

Establishment of an exponential equation:

The cutting force is affected by many factors; main factors affecting the cutting force comprise the back cutting depth aₚ and the feed rate f; in general, the main factors are included in the empirical equation; and the other factors are used as the correction coefficient of the empirical equation.

When performing experiments on the cutting force, all the factors having influence on the cutting force are kept unchanged, and only the back cutting depth aₚ is changed to perform the experiments. When the dynamometer measures different back cutting depths aₚ, the data of several cutting component forces are obtained, and then the obtained data are drawn on double logarithmic paper to form approximately a straight line. A mathematical equation of the cutting force is as follows:

Y=a+bX.

In the equation:

Y=1gF_{z} refers to the logarithm of the main cutting force F_{Z},

X=1gaₚ refers to the logarithm of the back cutting depth aₚ;

a=1gCₐₚ refers to a longitudinal intercept on a straight line F_{Z}−aₚ in logarithmic coordinates; and

b=tgα=x_{Fz} refers to a slope of the straight line F_{Z}−aₚ in log-log coordinates.

Both a and α can be directly measured from the FIG. 13.

Therefore, the above equation can be rewritten as:

1gF_{z}=1gCₐₚ+x_{Fz}1gaₚ.

The following equation can be obtained after finishing:

F_{Z}=Cₐₚaₚ^{X}^{_{Fz}}.

Similarly, a relational expression of the cutting force F_{X} and the feed rate f can be obtained as follows:

F_{Z}=C_{f}fₚ^{Y}^{_{Fz}}.

In the equation:

C_{f} refers to the longitudinal intercept of a straight line F_{Z}−f in log-log coordinates; and

Y_{Fz} refers to a slope of the straight line F_{Z}−f.

The empirical equation for calculating the cutting force can be obtained by combining the above two equations and influence of each of other minor factors on F_{Z} as follows:

F_{Z}=C_{FZ}aₚ^{X}^{_{Fz}}f^{Y}^{_{Fz}}K_{Fz};

C_{FZ} depends on the coefficients of the materials to be machined and the cutting conditions and can be obtained by substituting actual experimental data into the equation.

K refers to the product of correction coefficients of various factors on the cutting force when actual machining conditions do not match with the conditions for obtaining the empirical equation.

Similarly, the empirical equation of the feed force F_{X} and the back force F_{Y} can be obtained.

The above process can be adopted to predict the cutting force after completing the turning tool design, thereby providing technical guidance for the selection of reasonable cutting parameters.

After determining the cutting parameters such as the hack cutting depth aₚ the feed rate f and the cutting speed, v, lathe, machining parameters are inputted to the MQL supply system; and the cutting parameters are intelligently identified by establishing a parameter matching database in an early stage and are matched with the optimal liquid supply amount of the MQL supply system to realize intelligent supply of the cutting amount and the liquid supply amount.

Alternatively, when the working system is a CNC turning system, the MQL supply device is connected with the CNC system; programming codes of the CNC system are read; then, the parameters such as the back cutting depth aₚ, the feed rate f and the cutting speed ν in the identified codes are extracted and are fed back to the NMQL supply device; and the cutting parameters are intelligently identified by establishing the parameter matching database in the early stage and are matched with the optimal liquid supply amount of the MQL supply device to realize the intelligent supply of the cutting amount and the liquid supply amount.

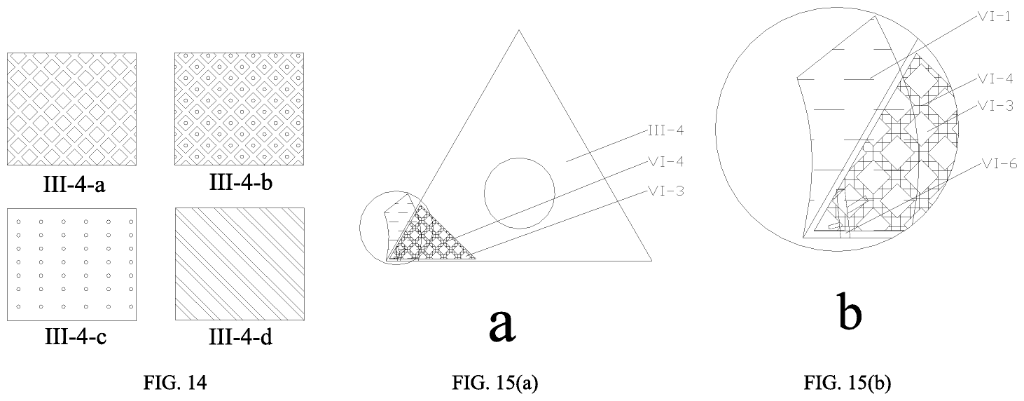

As shown in FIG. 14, the texture forms are classified into an open texture form III-4-a, a hybrid texture form III-4-b, a closed texture form III-4-c and a semi-open texture form III-4-d in the present invention. Tribological characteristics of the textures are related to the areal density (a ratio of the texture area to the total area in the area), depth and width. The textures in various forms can be analyzed by simulation software and then enter a friction and wear testing machine for friction and wear experiments to find the optimal areal density, depth and width of the textures. A secondary lubrication function described below refers to a function of supplying the lubrication liquid to a cutting region (tool/chip friction region) under the external action after the lubrication liquid is stored in the texture region. A chip accommodating function means that tiny chips will be brought into a texture groove in the cutting process and play a role of storage so as to reduce the friction and wear of other tools. The open texture III-4-a means that the fluid in the texture can flow freely in the texture, i.e., can move in one direction and also flow in a direction with a certain angle to the direction. The semi-open texture III-4-d, means that the fluid in the texture can only move in one direction under the action of the texture. The closed texture III-4-c means that the fluid in the texture does not move in other directions. The hybrid texture III-4-b is a combination of the open texture, the semi-open texture and the closed texture in pairs or in threes. The texture forms contain, but arc not limited to the illustration.

Compared with the semi-open texture III-4-d, the hybrid texture III-4-b and the closed texture III-4-c, the open texture III-4-a has more excellent lubrication liquid flow characteristics, and is easier to realize “secondary lubrication” during machining: i.e., microstructures with liquid conveying channels supply the MQL oil in texture depressions to the chip/tool friction regions, thereby reducing wear. However, the closed texture form III-4-c has better manufacturability than the open texture form III-4-a, i.e., the closed texture form III-4-c is simple to manufacture, but is easy to cause that the textures are blocked by the solid nanoparticles and the tiny chips during long-term use, thus a liquid lubricant in the NMQL liquid cannot come into play, but the closed texture form III-4-c is easier to manufacture in actual production. The semi-open texture form III-4-d has advantages and disadvantages of both the closed texture form III-4-c and the open texture form III-4-a, not only has a semi-flow channel for the MQL oil, but also is convenient for machining. Since the function of oil storage or “secondary lubrication” of the textures can, be brought into fill play, the anti-wear and friction-reducing performance of the semi-open texture perpendicular to the chip direction is more excellent than that of the semi-open texture form III-4-d in other directions. However, the liquid fluidity of the semi-open texture form III-4-d is inferior to that of the open texture form III-4-a. The hybrid texture form III-4-b is complicated in machining, and is easy to cause that a closed part in the hybrid texture form III-4-b is easily blocked during long-term use. Producers can select appropriate texture machining forms according to actual needs.

As shown in FIGS. 15(a) and 15(b), in the actual machining process, slender microscopic capillary channels VI-6 will be generated between the texture turning, tool VI-3 and the chips VI-1 due to the sliding friction of hard points on the chips VI-1. When the microscopic capillary channels VI-6 are communicated with the outside, microscale capillary flow enables the cutting fluid to penetrate into the friction region, thereby effectively improving the lubrication effect of the MQL oil. The capillary flow is a kind of spontaneous movement without driving of external force.

Since the MQL oil supplied by the MQL supply system IV is supplied in the form of small droplets after pneumatic atomization, the droplets are relatively high in speed and easier to enter the microscopic capillary channels VI-6. In addition, since the texture turning tool VI-3 is adopted in the process system, the microscopic capillary channels VI-6 are easier to communicate with the outside; therefore, the microscopic capillary channels VI-6 and the cutting fluid storage channels of the micro-textures all exist in the whole cutting and machining process, so that the MQL oil plays a maximum role of lubrication in the device, reduces the friction coefficients and the cutting force, obviously reduces energy required for removing unit materials and improving an energy utilization rate.

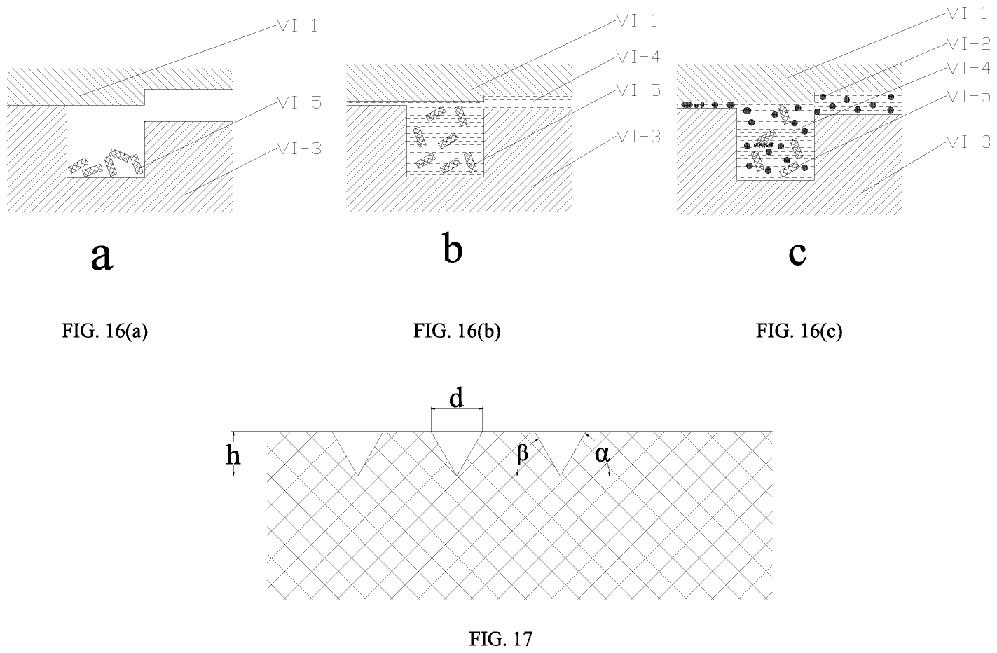

As shown in FIGS. 16(a)-16(c), the friction interface of the texture turning tool VI-3/chips VI-1 in NMQL conditions is analyzed to obtain a coupling effect of the NMQL and the micro-texture tool as follows.

1. The atomized MQL oil VI-4 is also spread in the chip/turning tool friction region to form a regional lubrication, oil film or a stable planar oil film, which can also reduce the friction coefficient of the friction region and reduce the wear and cutting force between the friction regions of the texture turning tool VI-3/chip VI-1, thereby prolonging the service life of the whole system. Under the NMQL conditions, the nanoparticles VI-2 exist so that the physical lubrication oil film is more easily generated on the friction interface between the texture turning tool VI-3 and the chips VI-1 by the MQL oil, thereby reducing the friction coefficient of a friction contact region and improving the surface machining quality. Meanwhile, the bearing-like effect of the nanoparticles improves the overall lubrication performance.

2. The textures have shown excellent wear resistance without adding any lubricant. However, under the NMQL conditions, the texture groove of the texture turning tool VI-3 exists so that the texture groove can store the MQL oil VT-4 and can supply the MQL oil VI-4 to the friction region in time when the lubrication conditions of the friction region are poor, i.e., the secondary lubrication effect, to realize a gain effect on lubrication on one hand, and can store the tiny chips VI-5 generated in the friction contact region to reduce the friction and wear caused by the tiny chips VI-5 on the other hand.

3. The strong heat transfer capacity of nanoparticles can take away the heat from the cutting region in time, thereby avoiding burn damage to the workpieces.

Under the combined action of the above two aspects, the process system can well ensure the surface integrity of the workpieces to be machined; and the service life of the process system can be prolonged, thereby realizing green manufacturing.

The MQL form is different from, the NMQL form. Due to the lack of nanoparticles, on one hand, the MQL form has lower heat transfer capacity than the NMQL form; such a lubrication condition is not suitable for machining materials with relatively low thermal conductivity or materials with high continuous machining temperature; and the textures can provide effects of secondary lubrication and chip accommodation in such a lubrication form, but bum is easily caused during machining due to the lack of heat transfer capacity.

Pouring type lubrication conditions are similar to the MQL, but the pouring type lubrication has the heat transfer capacity slightly better than the MQL, due to a large amount of liquid can be supplied continuously. The textures can provide the effects of secondary lubrication and chip accommodation. The pouring type lubrication enables a large amount of cutting fluid enter the cutting region in a liquid jet manner, but easily causes oil rash, folliculitis and other damages, and may produce carcinogenic substances to violate a concept of green machining.

Under dry cutting conditions, i.e., cutting conditions without any additional lubrication conditions, the texture can only provide the effect of chip accommodation, but cannot provide the effect of secondary lubrication. Meanwhile, the heat transfer capacity is also a major use obstacle.

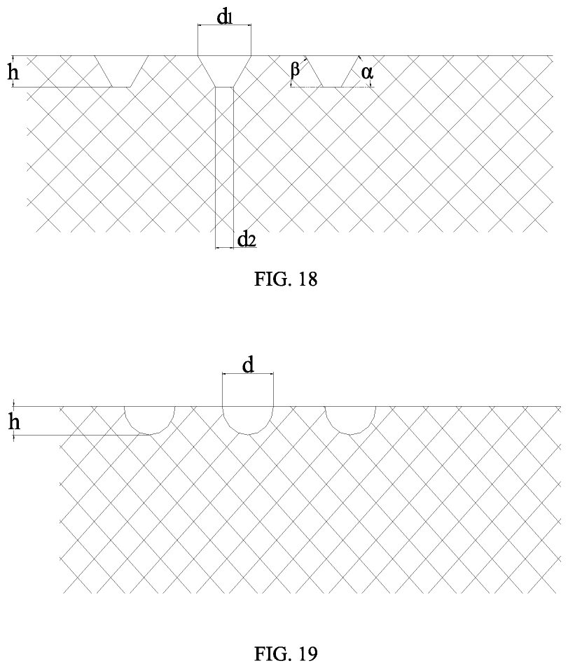

As shown in FIGS. 17, 18 and 19, a cross section of each type of texture can be any manufacturable two-dimensional shape, such as a triangle, a quadrangle, a polygon, a semicircle and a semi-ellipse. Various shape parameters and application situations are analyzed as follows.

For a triangular cross section, the shape has lower oil and chip accommodation regions than other shapes, i.e., the triangle is not conducive to secondary lubrication and chip accommodation at the same depth; the shape parameters mainly comprise a left inclination angle β, a right inclination angle α, a texture width d and a depth h; the left is a triangular edge approximate to a tool tip; and the larger the right inclination angle α is, the stronger the chip accommodating capacity of the texture groove is.

Let the area of the texture be S and the areal density of the texture be ϕ, then the oil storage and chip accommodation volume V₆₆ under this cross section is:

V_{Δ}=½d·h·S·ϕ.

For a quadrilateral cross section, compared with other shapes, the quadrilateral section may have larger oil and chip accommodation regions than other shapes, i.e., the quadrilateral section is conducive to the storage of the lubricant oil and the tiny chips at the same depth; and the shape parameters mainly comprise the left inclination angle β, the right inclination angle α, an upper texture width d₁, a lower texture width d₂ and the depth h.

The area of the texture is set as S and the areal density of the texture is set as ϕ; then the oil storage and chip accommodation volume V₅₈ under this cross section is:

V_{□}=½·(d₁+d₂)·h·S·99 .

For an elliptical, cross section, the elliptical cross section has moderate areas of the oil and chip accommodation regions at the same depth, but is easier to manufacture than the quadrilateral cross section when the lubrication liquid in the grooves impacted, and has performance intermediate between the quadrilateral cross section and the triangular cross section; and the shape parameters comprise d and h.

The area of the texture is set as S and the areal density of the texture is set as ϕ; then the oil storage and chip accommodation volume V_{O} under this cross section is:

$${V}_{O} = \frac{1}{2} \cdot π \cdot \frac{d}{2} \cdot h \cdot S \cdot φ .$$

The nanofluids in microchannels have properties as follows.

Density of the nanofluids: ρ_{nf}=(1−ϕ)ρ_{f}+ϕρₚ;

ρ_{nf} refers to the density of the nanofluids;

ϕ refers to a volume fraction;

ρ_{f} refers to the density of abase fluid; and

ρₚ refers to the density of the nanoparticles.

Dynamic viscosity of the nanofluids:

$${μ}_{nf} = {μ}_{f} \frac{1}{{( 1 - φ )}^{2.5}} ;$$

μ_{nf} refers to the dynamic viscosity of the nanofluids; and

μ_{f} refers to the dynamic viscosity of the base fluid.

Kinematic viscosity:

$${v}_{nf} = \frac{{μ}_{nf}}{{ρ}_{nf}} ;$$

ν_{nf} refers to the kinematic viscosity of the nanofluids.

Thermal conductivity:

$${k}_{nf} = \frac{{k}_{p} + 2 {k}_{f} + 2 ( {k}_{p} - {k}_{f} ) φ}{{k}_{p} + 2 {k}_{f} - 2 ( {k}_{p} - {k}_{f} ) φ} {k}_{f} ;$$

k_{nf} refers to the thermal conductivity of the nanofluids;

kₚ refers to the thermal conductivity of the nanoparticles; and

k_{f} refers to thermal conductivity of the base fluid.

Specific heat capacity: (ρcₚ)_{nf}=(1−ϕ)(ρcₚ)_{f}+ϕ(ρcₚ)ₚ;

(ρcₚ)_{nf} refers to the specific heat capacity of the nanofluids;

(ρcₚ)_{f} refers to the specific heat capacity of the base fluid; and

(ρcₚ)ₚ refers to the specific heat capacity of the nanoparticles.

Reynolds number calculation equation:

$$Re = \frac{\overline{u} {D}_{h}}{v} ;$$

Re refers to the Reynolds number;

ū refers to average flow rate;

Dₕ refers to an equivalent diameter of the microchannels;

ν refers to the kinematic viscosity;

in the equation:

$$\overline{u} = \frac{M}{N ρ {A}_{c}} ;$$

M refers to a mass flow;

N refers to the number of the microchannels; and

A_{c} refers to a cross-sectional area of each microchannel.

Coefficient of frictional resistance:

$$f = \frac{Δ {pD}_{h}}{2 ρ L {\overline{u}}^{2}} ;$$

f refers to the coefficient of frictional resistance;

Δp refers to a differential pressure;

Dₕ refers to the equivalent diameter of the microchannels; and

L refers to a length of the microchannels.

Prandtl number of heat transfer characteristics:

$${P}_{r} = \frac{μ {c}_{p}}{k} ;$$

Pᵣ refers to the Prandtl number of heat transfer characteristics;

cₚ refers to specific heat capacity at a constant pressure; and

k refers to the thermal conductivity of a working fluid.

Total heat, taken away by the nanofluids: Q=Mcₚ(Tₒ−Tᵢ);

Q refers to the, total heat taken away by the nanofluids;

Tₒ refers to an outlet temperature of the nanofluids; and

Tᵢ refers to an initial temperature of the nanofluids.

It is understandable that the illustration for reference terms “one embodiment”, “another embodiment”, “other embodiments”, “the first embodiment to the Nth embodiment” or the like in the illustration of the present description means that specific features, structures, materials or characteristics described in combination with the embodiment or example are included in at least one embodiment or example of the present invention. The schematic representation of the above terms does not necessarily refer to the same embodiment or example in the present description. Moreover, the described specific features, structures, materials or characteristics can be combined in an appropriate manner in any one or more embodiments or examples.

The above only describes preferred embodiments of the present disclosure and is not intended to limit the present disclosure. Various modifications and changes can be made to the present disclosure for those skilled in the art. Any modification, equivalent substitution, improvement and the like made within the spirit and principles of the present disclosure shall be included within the protection scope of the present disclosure.

We claim:

1. An electrocaloric assisted internal cooling texture turning tool, comprising:
an internal cooling turning tool handle, a direction-adjustable nozzle and an internal cooling turning tool blade, wherein
the internal cooling turning tool blade is arranged at one end of the internal cooling turning tool handle serving as a bearing device; an internal cooling turning tool pad is arranged between the internal cooling turning tool blade and a structure of the internal cooling turning tool handle bearing the blade;
the internal cooling turning tool handle is made of an electrocaloric material, is externally connected with an electric field, and is internally and externally coated with insulation coatings having excellent thermal conductivity;
an internal cooling turning tool blade pressing device is further arranged on the internal cooling turning tool handle; the internal cooling turning tool blade is tightly pressed on the internal cooling turning tool, handle by the internal cooling turning tool blade pressing device;
a texture is machined on a rake face of the internal cooling, turning tool blade;
the internal cooling turning tool blade pressing device has a hollow structure, and is also provided with the direction-adjustable nozzle; and the internal cooling turning tool blade pressing device is communicated with an internal channel of the direction-adjustable nozzle.

2. The electrocaloric assisted internal cooling texture turning tool according to claim 1, wherein the internal cooling turning tool pad has the same shape as the internal cooling turning tool blade and has thickness size and center hole size different from the internal cooling turning tool blade.

3. The electrocaloric assisted internal cooling texture turning tool according to claim 1, wherein the internal cooling turning tool blade and the internal cooling turning tool pad are located through an internal cooling turning tool positioning pin.

4. The electrocaloric assisted internal cooling texture turning tool according to claim 1, wherein the internal cooling turning tool blade pressing device is fixedly connected with the internal cooling turning tool handle through an internal cooling turning tool sealing screw; arid the internal cooling turning tool sealing screw is hollow.

5. The electrocaloric assisted internal cooling texture turning tool according to claim 1, wherein the direction-adjustable nozzle comprises a direction-adjustable nozzle gas channel and a direction-adjustable nozzle lubrication oil channel, and can mix and atomize gas and the MQL oil.

6. The electrocaloric assisted internal cooling texture turning tool according to claim 1, wherein the texture is an open texture, a semi-open texture, a closed texture and a hybrid texture.

7. A nanofluid minimal quantity lubrication (NMQL) intelligent working system, comprising:
a machine tool working system, an electrocaloric tool handle radiating fin movement system, an MQL supply system and a texture turning tool component, wherein
the MQL supply system and the texture turning tool component are mounted on the machine tool working system;
the electrocaloric tool handle radiating fin movement system is mounted on a turning tool holder and mainly radiates heat of the turning tool handle made of the electrocaloric material;
the MQL supply system mainly provides pulsed lubrication and cooling liquid for the texture turning tool component;
the texture turning tool component is the electrocaloric assisted internal cooling texture turning tool of any one of claim 1; workpieces mounted in the machine tool working system are rotated; the texture turning tool component performs linear motion under the action of the machine tool working system; and the texture turning tool component cuts the workpieces to generate chips, thereby removing materials of the workpieces.

8. The NMQL intelligent working system according to claim 7, wherein the electrocaloric tool handle radiating fin movement system comprises a radiating plate, a lower intake pipe, air cylinders and an upper intake pipe; the air cylinders are arranged below the radiating plate; the number of the air cylinders may be two; and each air cylinder is respectively connected to the upper intake pipe and the lower intake pipe;
the electrocaloric tool handle radiating fin movement system periodically electrifies the turning tool handle made of the electrocaloric material in a periodic cycle; and the radiating fin periodically moves along.

9. The NMQL intelligent working system according to claim 7, wherein the intelligent working system further comprises a turning tool wear state monitoring system V; the turning tool wear state monitoring system V integrates an infrared thermal imager acquisition module and an image acquisition device, and can monitor a wear state of the turning tool and the temperature of the turning tool component.

10. A control method based on the NMQL intelligent working system of any one of claim 7, comprising:
pouring formulated MQL oil or NMQL oil into the MQL supply system;
mounting the texture turning tool component in the machine tool working system, and then positioning and clamping;
mounting the workpieces above the machine tool working system, and then positioning and clamping;
determining cutting parameters, then inputting machine tool machining parameters into the MQL supply system, establishing a parameter matching database, intelligently identifying the cutting parameters, matching with an optimal liquid supply amount of the MQL supply system, and controlling an intelligent supply motor to move and drive a gear-rack transmission mechanism, thereby adjusting the amount of chips and realizing intelligent supply of the amount of chips and liquid supply amount;
the workpieces are always rotated in the process of machining the workpieces, while the texture turning tool component performs linear motion under the action of the machine tool working system; and the texture turning tool component cuts the workpieces to generate the chips, thereby removing the materials of the workpieces.

11. The control method of a process system for coupling NMQL with the texture tool according to claim 10, wherein when machining an initial position of the workpiece, an initial state of the turning tool'is acquired and stored;
after finishing machining one workpiece, the turning tool returns to the initial position, and an image of the turning tool blade is acquired and compared with the image of the turning tool in the initial state according to image blocks; a reference value of the turning tool wear state is obtained after comparison of the image blocks and data weighted accumulation;
the reference value can be compared with a turning tool wear threshold corresponding to precision requirements of the machined workpiece to decide whether to replace the turning tool,
wherein the weighted accumulation means that the wear of a portion near the cutting edge of the turning tool is given a higher weight, the wear of a portion far away from the cutting edge of the, turning tool is given, a lower weight, and cumulative addition is performed to obtain the reference value of the turning tool wear state.

12. The control method of the process system for coupling NMQL with the texture tool according to claim 10, further comprising:
applying an electric field in the internal cooling turning tool handle and the internal cooling turning tool pad; orderly arranging dipoles in the internal cooling turning tool handle and the internal cooling turning tool pad due to the action of the electric field, so that an entropy value of the entire component is reduced and the temperature is further risen;
unchanging the electric field, and radiating the temperature rise caused by reduction of the entropy value through the radiating plate;
removing the electric field, and at this moment, disorderly arranging the dipoles in the internal cooling turning tool handle and the internal cooling turning tool pad due to withdrawal of the electric field, so that the entropy value is increased and the temperature is reduced;
keeping the electric field still in a removed state, wherein the temperatures of the internal cooling turning tool handle and the internal cooling turning tool pad are lower than that of the internal cooling turning tool blade, and the heat is transferred to the turning tool handle at this moment; and the cycle is repeated to reduce the temperature of the workpiece.
